(19) United States
(12) Patent Application Publication
(10) Pub. No.: US 2025/0181244 A1
(43) Pub. Date: Jun. 5, 2025

(54) DETERMINING A POWERED-OFF DURATION OF A MEMORY SUB-SYSTEM

(71) Applicant: Micron Technology, Inc., Boise, ID (US)

(72) Inventors: Michael G. Miller, San Jose, CA (US); Gary F. Besinga, Boise, ID (US); Cory Michael Steinmetz, Boise, ID (US); William Nicholas Thanos, Scotts Valley, CA (US); Roy Leonard, San Jose, CA (US)

(21) Appl. No.: 18/935,153

(22) Filed: Nov. 1, 2024

Related U.S. Application Data
(60) Provisional application No. 63/605,887, filed on Dec. 4, 2023.

(51) Int. Cl. G06F 3/06

(52) U.S. Cl. CPC G06F 3/0611; G06F 3/0653; G06F 3/0679

(57) ABSTRACT

A processing device in a memory sub-system detects a power-on command for the memory device. The processing device obtains read information from a reference block of the memory device. The read information is based on reference data stored in the reference block. Based on the read information, the processing device determines an estimate of a duration for which the memory device was in a powered-off state. The processing device determines whether the duration satisfies a duration threshold, and responsive to determining the duration satisfies the duration threshold, the processing device initiates a folding operation for at least a subset of blocks of the memory device.

### RELATED APPLICATION

This application claims the benefit of U.S. Provisional Application No. 63/605,887 filed Dec. 4, 2023, the entire contents of which are hereby incorporated by reference.

### TECHNICAL FIELD

Embodiments of the disclosure relate generally to memory sub-systems, and more specifically, relate to determining a powered-off duration of a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various aspects of the disclosure.

FIG. 1 illustrates an example computing system that includes a memory sub-system in accordance with aspects of the disclosure.

FIGS. 2A-2B illustrate examples of voltage distributions before and after a data retention duration, in accordance with aspects of the disclosure.

FIG. 2C illustrates an example of a post-retention voltage distribution plot for a set of TLC memory cells, with illustrative read threshold voltages, in accordance with aspects of the disclosure.

FIG. 3 is a block diagram illustrating a scan and fold operation for a memory sub-system, in accordance with aspects of the disclosure.

FIG. 4 is a flow diagram of an example method for determining a power-off duration for a memory device, in accordance with aspects of the disclosure.

FIG. 5 is a flow diagram of an example method for determining a power-off duration for a memory device, in accordance with aspects of the disclosure.

FIG. 6 is a block diagram of an example computer system in which embodiments of the disclosure can operate, in accordance with aspects of the disclosure.

### DETAILED DESCRIPTION

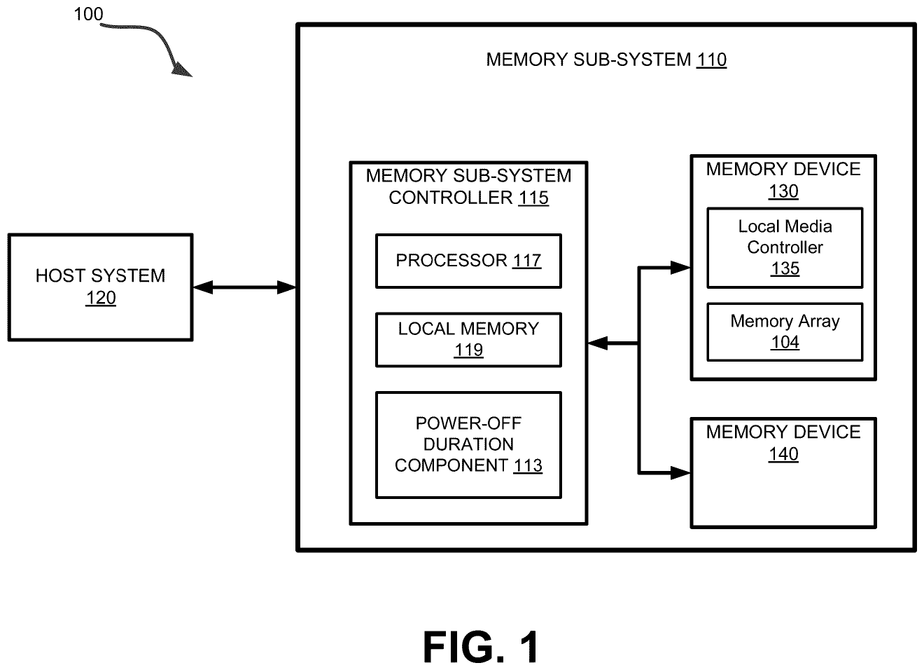

Aspects of the present disclosure are directed to determining a powered-off duration of a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where data retention of data is desired when no power is supplied to the memory device. For example, NAND memory, such as 3D flash NAND memory, offers storage in the form of compact, high density configurations. A non-volatile memory device is a package of one or more dice, each including one or more planes. For some types of non-volatile memory devices (e.g., NAND memory), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can be made up of bits arranged in a two-dimensional or a three-dimensional grid. Memory cells are formed onto a silicon wafer in an array of columns (also hereinafter referred to as bitlines) and rows (also hereinafter referred to as wordlines). A wordline can refer to one or more rows of memory cells of a memory device that are used with one or more bitlines to generate the address of each of the memory cells. The intersection of a bitline and wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane.

One example of a memory sub-system is a solid-state drive (SSD) that includes one or more non-volatile memory devices and a memory sub-system controller to manage the non-volatile memory devices. A given segment of one of those memory devices (e.g., a block) can be characterized based on the programming state of the memory cells associated with wordlines contained within the segment. When data is written to a memory cell of the segment for storage, the memory cell can deteriorate. This can cause the memory sub-system to experience a read failure at the memory cell or segment of memory (e.g., a block). Three mechanisms that potentially lead to read failure include: intrinsic NAND defect, intrinsic cell degradation, and extrinsic media stress. An “intrinsic NAND defect” can include physical defects to the segment of memory due to, for example manufacturing errors or damage sustained at the location where the memory sub-system is operating (e.g., damage sustained by the memory sub-system from being dropped). “Intrinsic cell degradation” can include memory segments that, due to repeated memory access operations (e.g., program/erase cycling) can no longer reliably store data. Accordingly, each memory cell of the segment can handle a finite number of memory operations performed before the memory cell is no longer able to reliably store data. “Extrinsic media stress” can include stresses on the segment of memory due to a number of factors, read disturb, slow charge loss, the passage of time, change in temperature, etc. For example, when data has been stored in the memory cells of a block for an extended period of time (e.g., in a datacenter), so called “data retention” stress can lead to significant levels of charge loss during that period of time (e.g., a data retention duration).

When performing certain memory access operations, the algorithms of the memory sub-system controller can attempt to read the data in one or more blocks of the drive. However, it is possible that memory sub-system controller fails to read data from a block because of a physical defect of the block (e.g., an intrinsic NAND defect or intrinsic cell degradation), or a logical defect of the block (e.g., extrinsic media stress that alters the charge states of the memory cells in the block). Altered charge states of memory cells in the block can include charge loss. For example, the charge loss can cause the margins between programming distributions to collapse making the data in different memory cells unreadable. The effects can occur whether the memory sub-system is in a powered-on state or in a powered-off state. When the memory sub-system is in a powered-on state, the memory sub-system controller can periodically refresh blocks based on a write time of the block in comparison to an operational time of the memory sub-system. For example, the memory sub-system controller can periodically refresh data stored in blocks of a memory sub-system that are older than “X quantity” of operational hours. Often, while charge loss can occur more rapidly when the memory sub-system is in a powered-on state, charge loss can still occur when the memory sub-system is in a powered-off state. When the duration of powered-off states for the memory sub-system are not considered in a data refresh plan for the memory sub-system, the memory sub-system controller can perform data refresh operations too infrequently, or inadvertently label a block as storing bad data. When the duration of powered-off states for the memory sub-system are not considered in the data refresh plan, calculations for read threshold voltages can be too high for the memory cells of the memory sub-system, and can cause read operations to have a higher read-error rate. However, without relying on external indicators (such as a system clock of the system that includes the memory sub-system, etc.) it can be challenging for the memory sub-system controller to account for powered-off durations of the memory sub-system.

Aspects of the present disclosure address the above and other deficiencies by determining a powered-off duration of a memory sub-system by measuring time based on a change in memory cell characteristics of a dedicated reference block. Charge loss can occur at a predictable rate, and thus for a given duration and temperature, a charge loss value or threshold voltage shift can reliably be predicted, or pre-characterized for a memory sub-system, based on physical characteristics of the memory sub-system. A dedicated reference block can be used to store reference data. The reference data can be compared to expected values for reference data after a data retention duration (e.g., a powered-off duration). In some embodiments, characteristics of the memory cells storing the reference data, such as voltage distribution threshold values can be compared to expected voltage distribution threshold values for cells storing the refence data after a powered-off duration.

During production of the memory sub-system, the reference block can be identified to the memory sub-system controller (e.g., defined as the reference block) and programmed with first reference data. At every power-on event, the memory sub-system can check the reference data stored at the reference block. If a quantity of read errors (e.g., number of failed bits) associated with reading the reference data exceeds an error threshold, the memory sub-system controller can refresh the data written to each block of the memory sub-system. In some embodiments, blocks of the memory sub-system can be refreshed with a fold operation (also referred to herein as “folding”). During a fold operation, data stored at a block can be relocated to a new block of the memory sub-system, or the data can be re-programmed to the same block in some embodiments. In some embodiments, the fold operation can be performed on blocks that contain data previously written to the block by the memory sub-system controller. In some embodiments, when the fold operation is triggered, new reference data can be written to a next page of the reference block. In some embodiments, the memory sub-system controller can maintain an ordered list of which blocks to fold. In this way, if the memory sub-system powers off before the all blocks of the memory sub-system have been folded, the memory sub-system controller can continue the folding operation for the next block in the folding list sequence after the memory sub-system is powered-on. In some embodiments, the ordered list can prioritize folding older blocks, or other blocks that are more susceptible to failure from charge loss.

In some embodiments, the memory sub-system controller can determine a powered-off duration based on reference data written to a reference block of the memory sub-system prior to the memory sub-system powering off. Upon startup, the memory sub-system controller can obtain read information from the reference data of the reference block. The memory sub-system controller can use the read information, as well as, in some embodiments, other memory sub-system information (e.g., real-time, and/or predetermined information about the memory sub-system) to determine an estimated duration that the memory sub-system was in a powered-off state (e.g., corresponding to a most recent powered-off state of the memory sub-system).

Advantages of the approach described herein include, but are not limited to, improved performance in the memory sub-system. For example, system latency for media scans (e.g., scans to determine whether a block should be refreshed) can be reduced, which can significantly reduce the overall time for refreshing old data in the memory sub-system. In another example, the memory sub-system can reliably refresh data (e.g., with folding operations) based on internal metrics, without relying on external system information (e.g., a system clock of a system coupled to the memory sub-system). By reading reference data from a reference block to determine a power-off duration of the memory device, the memory sub-system does not need to read each block before folding blocks to refresh data stored in the memory sub-system. In some embodiments, the time constraint for a scan and refresh operation can be primarily based on the block folding speed of the memory sub-system combined with the priority of the folding operation in the memory sub-system. In at least one embodiment, the scan and fold operation (determining whether to refresh all blocks of the memory sub-system) can be performed within a 12-hour operational window (e.g., 12-hours of on-time for the memory sub-system).

FIG. 1 illustrates an example of a computing system 100 that includes a memory sub-system 110 in accordance with some aspects of the disclosure. The memory sub-system 110 can include media, such as one or more volatile memory devices (e.g., memory device 140), one or more non-volatile memory devices (e.g., one or more memory device(s), such as memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access the memory components (e.g., the one or more memory device(s) such as memory device 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

Memory device 130 and memory device 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include not-and (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory device(s), such as memory device 130, can include one or more arrays of memory cells. One type of memory cell, for example, single level cells (SLC) can store one bit per cell. Other types of memory cells, such as multi-level cells (MLCs), triple level cells (TLCs), and quad-level cells (QLCs), can store multiple bits per cell. In some embodiments, each memory device 130 can include one or more arrays of memory cells such as SLCs, MLCs, TLCs, QLCs, or any combination of such. In some embodiments, a particular memory device can include an SLC portion, and an MLC portion, a TLC portion, or a QLC portion of memory cells. The memory cells of the memory device 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, electrically erasable programmable read-only memory (EEPROM).

A memory sub-system controller 115 (or memory sub-system controller 115 for simplicity) can communicate with the memory device(s) (e.g., memory device 130) to perform operations such as reading data, writing data, or erasing data at the memory device 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device(s) (e.g., memory device 130). The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory device 130. The memory sub-system controller 115 can further include host interface circuitry to communicate with the host system 120 via the physical host interface. The host interface circuitry can convert the commands received from the host system into command instructions to access the memory device(s) (e.g., memory device 130) as well as convert responses associated with the memory device(s) (e.g., memory device 130) into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory device(s) (e.g., memory device 130).

In some embodiments, the memory device(s) (e.g., memory device 130) include local media controllers 135 that operate in conjunction with memory sub-system controller 115 to execute operations on one or more memory cells of the memory device(s) (e.g., memory device 130). An external controller (e.g., memory sub-system controller 115) can externally manage the memory device 130 (e.g., perform media management operations on the memory device(s) (e.g., memory device 130)). In some embodiments, a memory device 130 is a managed memory device, which is a raw memory device (e.g., memory array 104) having control logic (e.g., local media controller 135) for media management within the same memory device package. An example of a managed memory device is a managed NAND (MNAND) device. Memory device(s) (e.g., memory device 130), for example, can each represent a single die having some control logic (e.g., local media controller 135) embodied thereon. In some embodiments, one or more components of memory sub-system 110 can be omitted.

In some embodiments, the memory sub-system 110 includes a power-off duration component 113 that can determine a power-off duration for a memory sub-system. In some embodiments, power-off duration component 113 can detect a power-on command for the memory device and obtain read information from a reference block of the memory device. Based on the read information, the power-off duration component 113 can determine an estimate of a duration for which the memory device was in the powered-off state. In some embodiments, the estimate for the duration for which the memory device was in the powered-off state can be based on one or more values of a pre-characterization table. The values of the pre-characterization table can be determined during production of the memory sub-system, and can be based on physical and/or logical characteristics of the memory sub-system. Responsive to determining the duration satisfies a duration threshold, the power-off duration component 113 can initiate a folding operation for at least a subset of the blocks of the memory device.

In some embodiments, power-off duration component 113 can determine a charge-loss value associated with the reference block. In some embodiments, power-off duration component 113 can determine a read threshold voltage adjustment associated with a charge loss experienced by the memory cells storing the reference data. In some embodiments, the read threshold voltage adjustment can be determined using values from one or more pre-characterized tables that are based on physical characteristics of the memory sub-system 110, and one or more expected operating conditions for the memory sub-system 110. Further details with regards to the operations of power-off duration component 113 are described below.

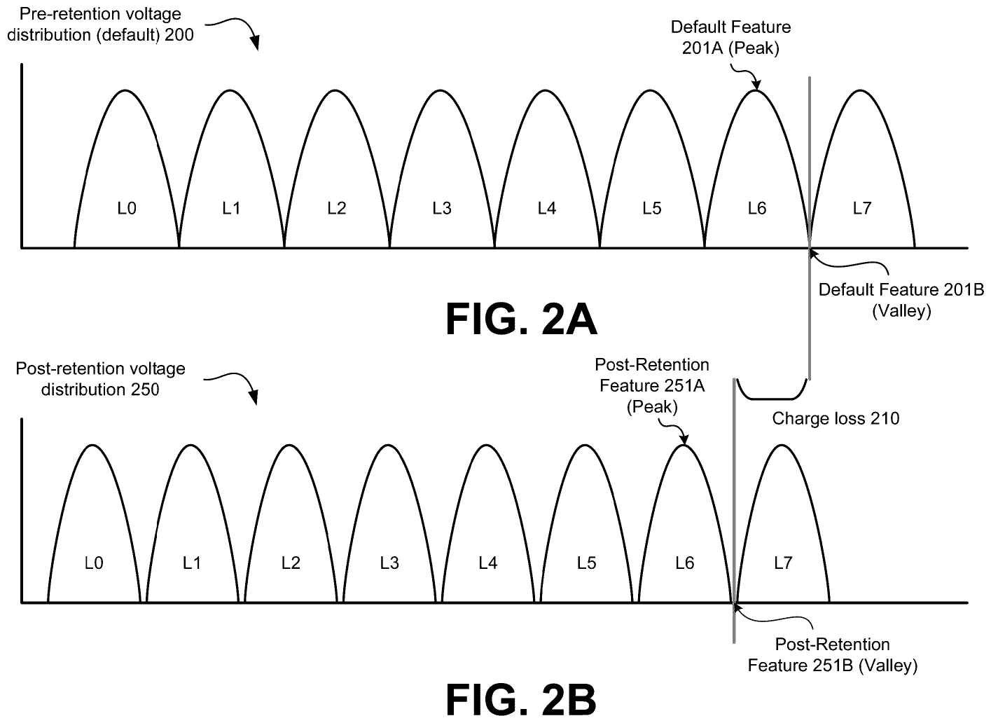

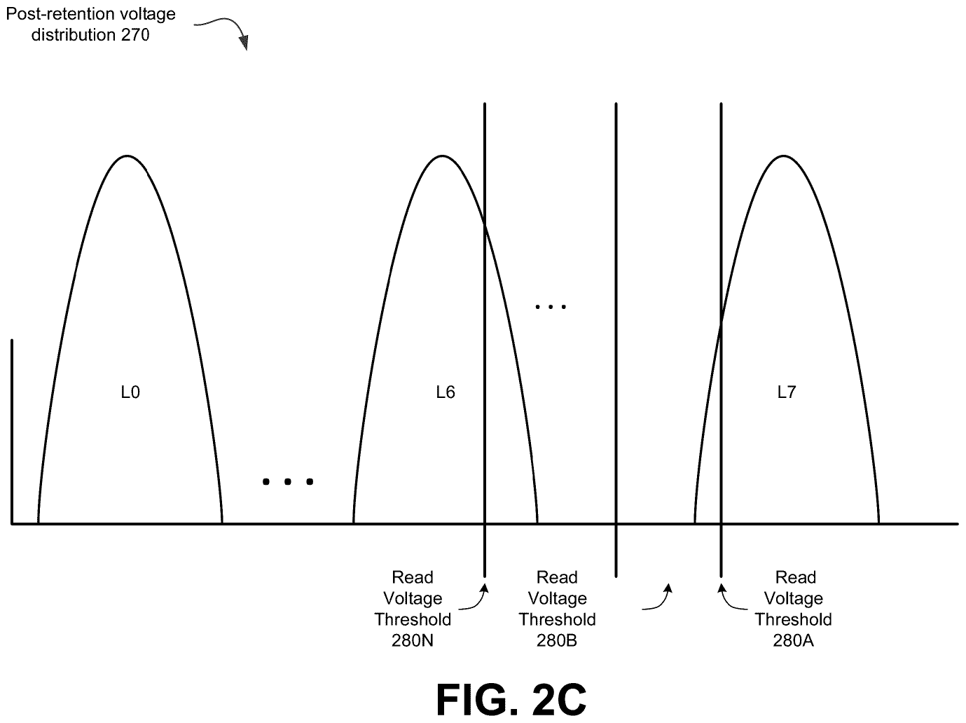

FIGS. 2A-2B illustrate examples of voltage distributions before a data retention duration, e.g., plot 200 of FIG. 2A, and after a data retention duration, e.g., plot 250 of FIG. 2B, in accordance with aspects of the disclosure.

In FIG. 2A, the plot 200 of the pre-retention (default) voltage distribution is an example of a TLC voltage distribution with voltage levels L0-L7 of a block in a memory device. A feature of the voltage distribution can, for example and in some embodiments, refer to a peak of the voltage distribution (e.g., default feature 201A) or a valley of the voltage distribution (e.g., default feature 201B). Additional features of the voltage distribution can include, for example, a median, a mean, or a mode. In some embodiments, the plot 200 can represent a programming voltage distribution of a portion of a memory device (e.g., a block, set of wordlines, etc.). In some embodiments, the pre-retention voltage distribution of plot 200 can represent a voltage distribution of the portion of the memory device shortly after the programming occurred.

In FIG. 2B, the plot 250 of the post-retention voltage distribution is an example of the same TLC volage distribution illustrated in FIG. 2A, but after a period of data retention (e.g., a data retention duration). Over time, due to extrinsic media stresses, the voltage distribution of the block can shift. In some embodiments, the shape of the voltage distribution (e.g., the distance between adjacent peaks or adjacent valleys) can change over time. In some embodiments, the charge loss experienced by blocks of a memory device can depend in part on a duration of time since data was written to the block (e.g., a data retention duration). For example, and in some embodiments, the charge loss experienced by a block of the memory device can be expressed as a linear- or non-linear function. For example, and in some embodiments, the charge loss experienced by a block in a memory device can be expressed as a function of time since data was written to the block.

Charge loss 210 in FIGS. 2A and 2B illustrate a charge loss experienced by a block after a data retention duration. Charge loss 210 can be measured between any two relative points of a voltage distribution for the same block. In the illustrative example, charge loss is measured with reference to the valley between L6 and L7 of plot 200 of the pre-retention voltage distribution and plot 250 of the post-retention voltage distribution respectively (e.g., default feature 201B, and post-retention feature 251B). While not illustrated, in the charge loss 210 can be measured between other relative points on a voltage distribution for the same block, such as between default feature 201A and post-retention feature 251A (e.g., the peak of L6). As described above, and in some embodiments, charge loss 210 can be measured using one or more data state metrics obtained from the block before the data retention (e.g., corresponding to the pre-retention voltage distribution) and one or more data state metrics obtained from the block after the data retention (e.g., corresponding to the post-retention voltage distribution). Charge loss 210 of a block can be a charge loss as a predictable function of time. Thus, for a time, T, a value of an expected charge loss can be calculated. The charge loss 210 measured at the block can depend on physical characteristics of the memory device. In some embodiments, charge loss 210 in various conditions can be estimated during production of the memory device (e.g., “pre-characterized”) and these estimates, along with conditions that contribute to these estimates, can be stored in metadata tables of the memory device. In some embodiments, a memory sub-system controller (or another component of the memory sub-system, such as power-off duration component 113) can use these pre-characterized reference tables to select a read threshold voltage for performing a test read operation (e.g., a read operation of the reference block at startup). In some embodiments, the memory sub-system controller, such as memory sub-system controller 115 can incrementally adjust the read threshold voltage based on the pre-characterization tables stored as metadata.

For example, and in some embodiments, the memory sub-system controller 115 can select a first estimate for an adjustment to the read threshold voltage from the pre-characterization table. After performing a read operation, the memory sub-system controller 115 can determine, based on one or more data state metrics (e.g., “read information”) received in response to the read operation, whether the estimated adjustment to the read threshold voltage is satisfactory. If the estimated adjustment is not satisfactory (e.g., the read operation fails to satisfy an error threshold), the memory sub-system controller 115 can adjust the read threshold voltage. In an illustrative example, if the read threshold voltage is adjusted down by “X” millivolts and a read operation returns an error count (e.g., a bit error count) that exceeds an error threshold, the memory sub-system controller 115 can adjust the original read threshold voltage down by “X+Y” millivolts, and perform another read operation. This process can be performed iteratively until the read operation returns an error value that satisfies the error threshold. In another illustrative example, if the read threshold voltage is adjusted down by “X” millivolts and a read operation returns an error count (e.g., a bit error count) that satisfies the error threshold, the memory sub-system controller 115 can adjust the original read threshold voltage down by “X−Y” millivolts, and perform another read operation. This process can be performed iteratively until the read operation returns an error value that exceeds the error threshold. Using the pre-characterization metadata tables for expected charge loss and the adjusted read threshold voltage value, the memory sub-system controller can estimate a duration for which the memory device was in a powered-off state. For example, and in some embodiments, if the charge loss 210 for a certain duration is predicted to be “X” millivolts, the adjustment to the read threshold voltage can also be “X” millivolts.

FIG. 2C illustrates an example of a post-retention voltage distribution plot 270 of a set of TLC memory cells, with illustrative read threshold voltages 280A-N in between voltage level L6 and voltage level L7. In some embodiments, the read threshold voltages 280A-N can be between other voltage levels (e.g., between voltage level LO and LI, for example). Read threshold voltages 280A-N can represent values of read threshold voltages that correspond to pre-characterized estimated power-off durations for the memory device.

In the illustrative example of FIG. 2C, read threshold voltage 280A reflects the read threshold voltage 280 that corresponded to when the data was originally written to the set of memory cells. That is, in the time following the write operation before the retention period, the read threshold voltage 280A could be used to accurately read data from the set of memory cells (e.g., reads performed with the read threshold voltage 280A satisfied a read error threshold). The read threshold voltage 280B reflects the read threshold voltage 280 that can be used after the retention period to accurately read data from the set of memory cells, and the read threshold voltage 280N reflects the read threshold voltage 280 that can be used in the future after another one or more retention periods to accurately read data from the set of memory cells.

During production of the memory sub-system values for each read threshold voltage 280A-N can be pre-determined based on expected retention conditions (e.g., powered-off conditions), a duration, and physical characteristics of the memory sub-system. Illustratively, for example, read threshold voltage 280B can correspond to a powered-off retention at a certain temperature for 1-year of a particular memory sub-system, and read threshold voltage 280N can correspond to a powered-off retention at the certain temperature for 2-years of the particular memory sub-system. Once these values are determined, they can be stored as metadata in a data structure of the memory sub-system. In some embodiments, when a memory sub-system determines an estimate for the duration of a powered-off state of the memory device, the memory sub-system can perform a read operation at one or more of the read threshold voltages 280A-N, and select the read threshold voltage 280 that produces an error value that satisfies an error threshold. In some embodiments, the error threshold can be the same as, or similar to the read error threshold used for determining read errors pertaining to reading host data from the memory device. After selecting the read threshold voltage 280 (illustratively here, read threshold voltage 280B), the memory sub-system can determine an estimated power-off duration for the memory device based on the table of pre-characterized read threshold voltages 280A-N and corresponding estimated power-off durations for the memory device.

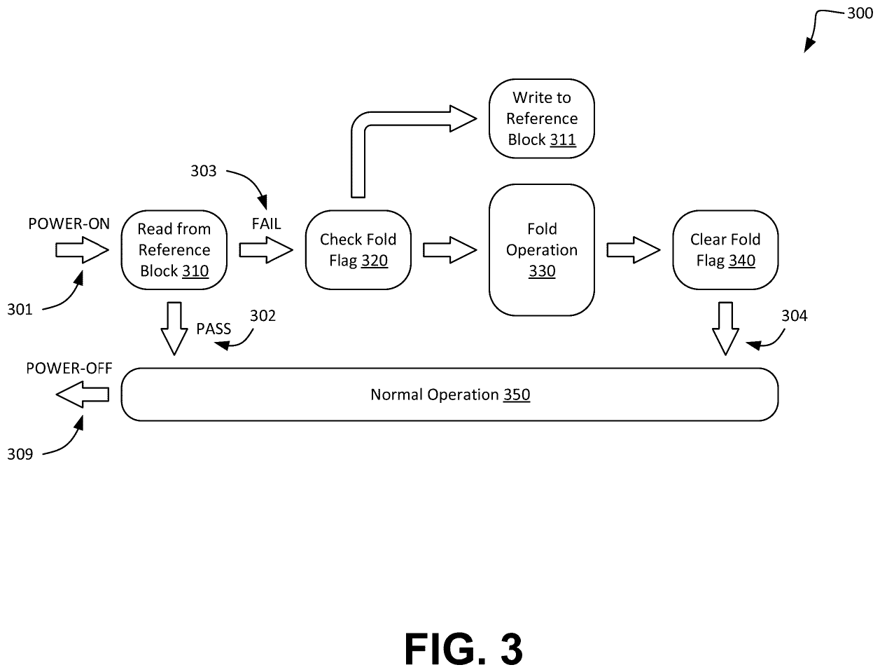

FIG. 3 is a block diagram illustrating a scan and fold operation 300 for a memory sub-system, in accordance with aspects of the disclosure. The scan and fold operation 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the scan and fold operation 300 is performed by the power-off duration component 113 of FIG. 1. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment.

After a power-on event 301, the memory sub-system can read data from a reference block at block 310. In some embodiments, the first reference data stored at the reference block can be written during production of the memory sub-system. If the memory sub-system determines that the read information from the reference block indicates a power-off duration of the memory sub-system has not exceeded a threshold, then the scan and fold operation 300 is in the pass state 302, and the memory sub-system can proceed to normal operation at block 350. In the context of this disclosure, “normal operation” of the memory sub-system can refer to operations of a memory sub-system such as processing memory request from a host, performing internal memory maintenance operations such as garbage collection, etc. In some embodiments, proceeding to normal operation can include performing a subsequent memory operation at the memory device. In some embodiments, normal operations can be performed concurrently with the scan and fold operation 300. For example, and in some embodiments, the scan and fold operation 300, after being initiated, can be performed as a background task, while host requests are prioritized by the memory sub-system.

If the power-off duration of the memory sub-system has exceeded a threshold, then the scan and fold operation 300 is in the fail state 303. After the fail state 303, the memory sub-system can check the fold flag at block 320. If the fold flag indicates that a fold operation was previously initiated but not concluded, the memory sub-system can continue the where the previously initiated fold operation was paused. If the fold flag does not indicate that a fold operation was previously initiated but not concluded, the memory sub-system can start folding a first block of the memory sub-system at block 330. Additionally, if the fold flag does not indicate that a fold operation was previously initiated but not concluded, the memory sub-system can write reference data to a reference block at block 311. This reference data can indicate when the folding operation started and can be used by a future scan and fold operation 300 to determine whether a power-off duration of the memory sub-system exceeds a threshold. In some embodiments, the write operation at block 311 can be performed immediately before a power-off request 309. That is, if the fold flag does not indicate that a fold operation was previously initiated but not concluded, after receiving a power-off request, but before entering the power-off state, the memory sub-system can write reference data to the reference block at block 311.

In some embodiments, the folding operation of block 330 can prioritize folding certain blocks before other blocks. For example, and in some embodiments, a memory sub-system with a block version counter (or other block age indicator) can prioritize folding older blocks before newer blocks at the folding operation of block 330. In another example, and in some embodiments, a memory sub-system with multiple memory cell types can prioritize folding blocks associated with memory cells that have stricter retention tolerances before folding blocks associated with memory cells with less strict retention tolerances. In an illustrative example, the memory sub-system with a set of QLC memory cells and a set of TLC memory cells can prioritize folding blocks associated with the set of QLC memory cells before folding blocks associated with the TLC memory cells. In some embodiments, the memory sub-system can track which blocks have been folded and which blocks have yet to be folded with one or more respective lists. For example, and in some embodiments, the memory sub-system can maintain a metadata structure listing a block identifier for each block that has been folded since a folding operation has commenced, and a separate metadata structure listing a block identifier for each block that has not been folded since the folding operation has commenced. Once a given block has been folded, and before folding a second block, the memory sub-system can update each respective metadata structure to indicate that the given block has been folded. In another example, and in some embodiments, the memory sub-system can maintain one metadata structure that merely lists block identifiers for each block that either has, or has not, been folded.

After folding every block of the memory sub-system at block 330, the memory sub-system can clear the fold flag at 340. In some embodiments, at block 340 the memory sub-system can update the read location of the reference block for performing the read operation at block 310 after a power-on event 301 event. That is, initial reference data can be written to a first portion (e.g., a first segment, a first wordline, first page, etc.) of a the reference block, and the memory sub-system can read from that first portion at every power-on event 301 until the read location is changed. The read location can be changed to a second portion in response to writing second reference data to the second portion of the reference block, and receiving an indication to check the memory power-off duration against the second portion of the reference block. In some embodiments, the indication for which portion of the reference block to read at block 310 can be stored as a metadata table that is incremented each time the fold flag is cleared at block 340. In some embodiments, the indication for which portion of the reference block to read at block 310 can be determined based on other factors, such as memory sub-system operational conditions, physical characteristics, read information from the reference block, or a most-recently written reference data to the reference block (e.g., to a certain portion of the reference block) at block 311. In embodiments where the memory sub-system maintains one or more lists of blocks pertaining to the folding operation, the fold flag can be indicated once one or more of the respective block folding lists is empty.

Once the fold flag has been cleared, the memory sub-system can exit 304 the scan and fold operation to normal operations at block 350. It can be noted that the memory sub-system can exit 304 the scan and fold operation 300 at other points, such as at pass state 302, or of the memory sub-system receives a power-off request 309. In embodiments where memory sub-system receives a power-off request 309 before the folding operation at block 330 can fold every block of the memory sub-system, the memory sub-system exits the scan and fold operation 300 before block 340, and thus the fold flag will indicate at a subsequent power-on event 301 that the folding operation at block 330 was previously initiated but not concluded.

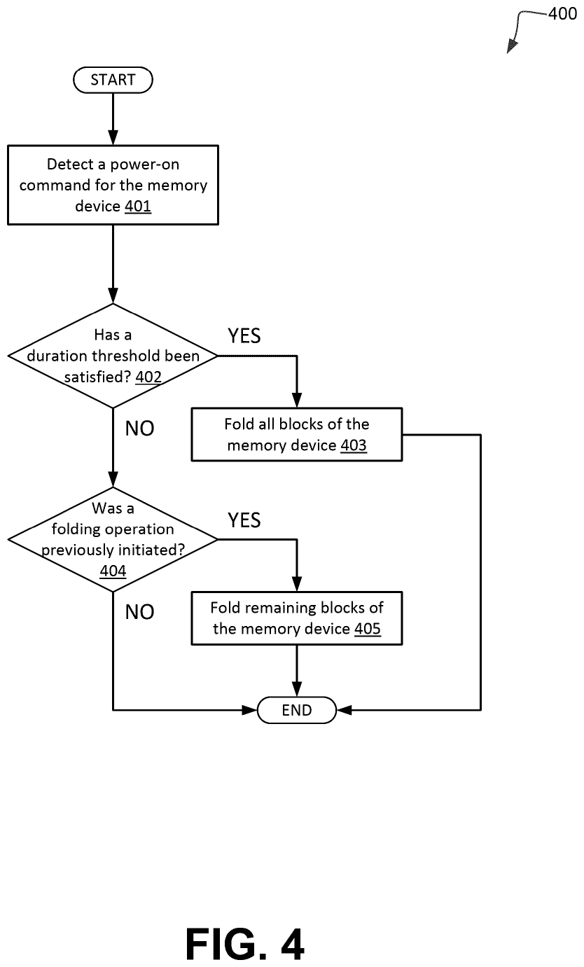

FIG. 4 is a flow diagram of an example method for determining a power-off duration for a memory device, in accordance with aspects of the disclosure. The method 400 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400 is performed by power-off duration component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible. For clarity and brevity, details with respect to the scan and fold operation 300 of FIG. 3 are not included in the description of the method 400 and operations 401-405 of FIG. 4. That is, insofar as the operations of method 400 include aspects of the scan and fold operation 300, those aspects retain the same, or similar function or structure as described above with in FIG. 3.

At operation 401, the processing logic (e.g., power-off duration component 113) detects a power-on command for the memory device. The power-on command can be received when the memory device or memory sub-system is in a powered-off state, or reduced-power state (where a reduced-power state can refer to a “standby” state).

At operation 402, the processing logic determines whether a duration threshold has been satisfied (e.g., the power-off duration of the memory device is equal to or greater than the duration threshold). If the duration threshold has been satisfied, processing logic proceeds to operation 403. If the duration threshold has not been satisfied, processing logic proceeds to operation 404.

At operation 403, responsive to determining the duration threshold has been satisfied, processing logic folds all blocks of the memory device. When the duration threshold has been satisfied, that is when a power-off duration of the memory device has exceeded a duration threshold, all blocks of the memory device will need to be folded.

At operation 404, responsive to determining the duration threshold has not been satisfied, processing logic determines whether a folding operation was previously initiated. If a folding operation was previously initiated, processing logic proceeds to operation 405. If a folding operation was not previously initiated, processing logic ends the method 400.

At operation 405, responsive to determining a folding operation was previously initiated, processing logic folds remaining blocks of the memory device. As described with reference to FIG. 3, in some embodiments, the memory sub-system (e.g., using power-off duration component 113) can maintain block folding lists. Upon determining a folding operation was previously initiated, processing logic can refer to these block folding lists as an indicator for which blocks to fold next. In some embodiments, these folding lists can be used at operation 404 to determine whether the folding operation was previously initiated. For example, and in some embodiments, a partially filled folded block list can indicate that a folding operation was previously initiated. In this way, operations 404 and 405 can be performed concurrently in some embodiments. In some embodiments, after operation 404 or 405, processing logic can perform a subsequent memory operation at the memory device (e.g., ending the method 400).

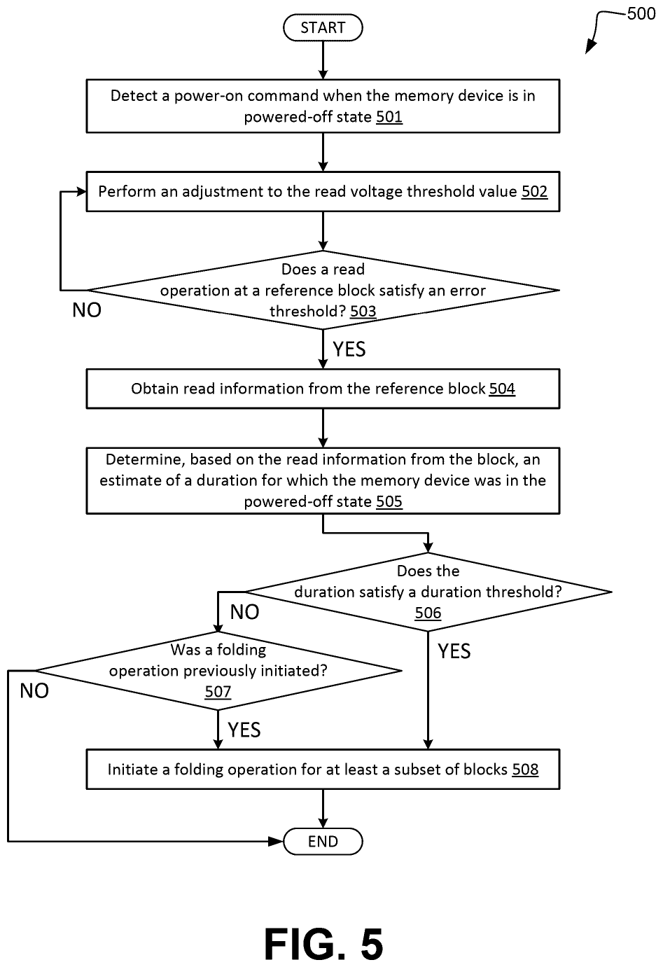

FIG. 5 is a flow diagram of an example method for determining a power-off duration for a memory device, in accordance with aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by power-off duration component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 501, the processing logic (e.g., power-off duration component 113) detects a power-on command when the memory device is in a powered-off state. The power-on command can be received when the memory device or memory sub-system is in a powered-off state, or reduced-power state (where a reduced-power state can refer to a “standby” state).

At operation 502, the processing logic performs an adjustment to the read threshold voltage value. In some embodiments, operations 502 and 503 can be performed iteratively, as described above with reference to FIGS. 2A-2B, and the read threshold voltage value can be adjusted until a read operation satisfies an error threshold.

In some embodiments, processing logic can determine a charge loss value for the block. In some embodiments, the charge loss value can be used to estimate the read threshold voltage adjustment and/or in comparison with the read threshold voltage adjustment to determine a duration that the memory device was in a powered-off state. The charge loss value can be based on a feature of a voltage distribution of the block, or a portion of the block. For example, in a TLC memory device, as illustrated in FIGS. 2A-B, the charge loss value can be based on a valley between a highest voltage distribution (e.g., an L7 voltage distribution) and a next highest voltage distribution (e.g., an L6 voltage distribution). Returning to FIG. 5, in some embodiments, processing logic can measure the voltage value of the feature of the voltage distribution, and compare the measured voltage value against a default voltage value for the given feature (e.g., an initial, or programmed voltage value). The difference between the measured voltage value and the default voltage value can be the charge loss value. The default voltage value can be based on the particular feature of the voltage distribution, such as is described above with reference to FIGS. 2A-B. In some embodiments, different portions of a block can have different charge loss values and charge loss thresholds corresponding to features of respective voltage distributions. In some embodiments. processing logic can determine which portion of the block is used to determine the charge loss value based on a predetermined order or process, memory device operation conditions, or a command from the memory sub-system. For example, and in some embodiments, a first portion of a block (e.g., a first set of wordlines) can have a first charge loss value corresponding to an L7 voltage distribution, while a second portion of a block (e.g., a second set of wordlines) can have a second charge loss value corresponding to an L7 voltage distribution. In another example, and in some embodiments, a first portion of the voltage distribution (e.g., L0-L3) can correspond to a first charge loss value (or first set of charge loss values) while a second portion of the voltage distribution (e.g., L4-L7) can correspond to a second charge loss value (or second set of charge loss values).

At operation 503, the processing logic determines whether the read operation at the reference block (using the adjusted read threshold voltage value) satisfies an error threshold. If the read operation does satisfy the error threshold, processing logic proceeds to the next operation, operation 504. If the read operation does not satisfy the error threshold, processing logic returns to operation 502. In some embodiments, the error threshold can be based on an error bit count associated with a the portion of the reference block storing the reference data (e.g., when a bit error rate (BER) is exceeded). In some embodiments, processing logic can perform a read strobe which returns information about the voltage levels of the memory cells, which can be checked against values in a database, programmed values, and/or expected voltage states (e.g., expected read information). If the information returned by the read strobe does not match the expected voltage states of the memory cells, the memory sub-system 110 can indicate the read operation does not satisfy the error threshold. For example, error correcting code (ECC) implemented by the memory sub-system controller 115 can examine data read from the block and identify any errors (e.g., bit-flip errors) using various techniques, such as parity information, hard and soft decoding, etc. The presence of such errors, including correctable or uncorrectable errors, can be interpreted as a failure of the memory access operation.

In some embodiments the reference block can be a dedicated block in the memory sub-system. In some embodiments, the memory sub-system can select a new reference block if the dedicated reference block fails due to intrinsic, or extrinsic stresses. In some embodiments, the memory sub-system can maintain a primary reference block and one or more secondary reference blocks which can be used for redundancy in the event the primary reference block fails. In some embodiments, the read operation at the reference block is performed on a first portion of the reference block containing reference data. The reference data can be written to the first portion of the reference block prior to a receiving a power-off command for the memory sub-system and/or in response to initiating a folding operation to refresh data stored on blocks of the memory sub-system. In some embodiments, the reference data is not written to recover the data that is written, but rather to compare the charge states of memory cells storing the reference data to expected (or initial) charge states of memory cells storing the reference data. In some embodiments, the reference data can be dummy data. Dummy data can be random, pseudo-random, or any other form of data.

At operation 504, responsive to determining the read operation satisfies the error threshold, processing logic obtains read information from the reference block. In some embodiments, read information can be obtained as data state metrics regarding the voltage distributions of memory cells containing the reference information stored at the reference block. In some embodiments, the error threshold can refer error metrics, such as a BER, and can be configured based on the characteristics of the memory sub-system. The read information can indicate the quality of the predicted read threshold voltage. For example, if the read information indicates a high error value, or an error value that exceeds the error threshold, the predicted read threshold voltage can be of lower quality (e.g., a poor reference value for determining the power-off duration). In another example, if the read information indicates a low error value, or an error value that does not exceed the error threshold, the predicted read threshold voltage can be of higher quality (e.g., a suitable reference value for determining the power-off duration).

At operation 505, the processing logic determines, based on the read information from the block, an estimate of a duration for which the memory device was in a powered-off state. In some embodiments, the memory sub-system can include a set of read threshold voltage values, with each read threshold voltage value corresponding to an estimated duration that the memory device was in a powered off state. The estimated durations can be based on physical characteristics of the memory device and expected operating conditions (or “retention bake” conditions). Processing logic can perform one or more read operations at the one or more pre-characterized read threshold voltage values. As described above with reference to FIG. 2C, if an error value associated with performing the read operation at the selected read threshold voltage satisfies the error threshold, processing logic can determine the estimated power-off duration for the memory device is the pre-characterized duration associated with the respective read threshold voltage. If the error value associated with performing the read operation at the selected read threshold voltage does not satisfy the error threshold, processing logic can select another read threshold voltage.

At operation 506, the processing logic determines whether the duration (e.g., the powered-off duration) satisfies a duration threshold. If the duration satisfies the duration threshold, processing logic proceeds to operation 508. If the duration does not satisfy the duration threshold, processing logic proceeds to operation 507.

At operation 507, responsive to determining the duration does not satisfy the duration threshold, processing logic determines whether a folding operation was previously initiated. If the folding operation was previously initiated, processing logic proceeds to operation 508. If the folding operation was not previously initiated, processing logic ends the method 500.

At operation 508, responsive to determining that a folding operation is required (e.g., either at operation 506, or at operation 507) processing logic initiates a folding operation for at least a subset of blocks. In some embodiments, the subset of blocks can include all blocks of the memory sub-system. In some embodiments, the subset of blocks can include all blocks which have not been folded since the duration satisfied the duration threshold (e.g., since a fold flag has been been set). In some embodiments, the folding operation can prioritize folding blocks based on a memory cell structure associated with the blocks, a block age, a type of data stored in the block (e.g., high-priority data vs. lower-priority data, host data vs. system data), etc. In some embodiments, responsive to initiating a folding operation, processing logic can write second reference data to the reference block. The second reference data can be written to a second portion of the reference block (e.g., the original reference data is not overwritten by the second reference data). In some embodiments, after operations 507 or 508 respectively, processing logic can end the method 500 by performing a subsequent memory operation at the memory device.

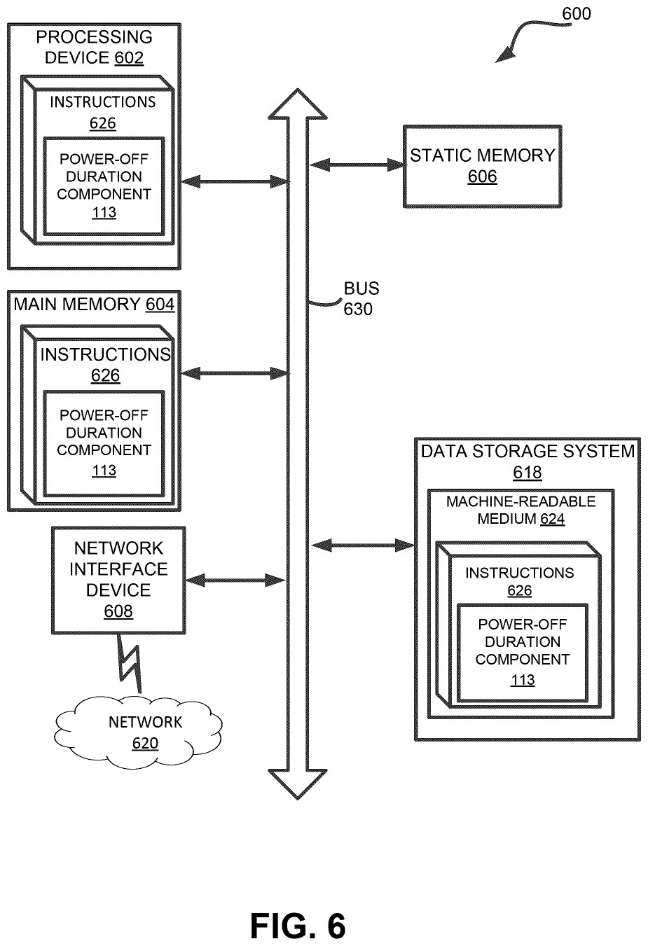

FIG. 6 illustrates an example of a computer system 600 within which a set of instructions, for causing the machine to perform any one or more of the methodologies discussed herein, can be executed, in accordance with aspects of the disclosure. In some embodiments, the computer system 600 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the power-off duration component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

In some embodiments, computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage system 618, which communicate with each other via a bus 630.

Processing device 602 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 602 can also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein. The computer system 600 can further include a network interface device 608 to communicate over the network 620.

The data storage system 618 can include a machine-readable storage medium 624 (also known as a computer-readable medium) on which is stored one or more sets of instructions 626 or software embodying any one or more of the methodologies or functions described herein. In some embodiments, the data storage system 618 can include a computer-readable non-transitory storage medium, and can be operatively coupled to the processing device 602. The instructions 626 can also reside, completely or at least partially, within the main memory 604 and/or within the processing device 602 during execution thereof by the computer system 600, the main memory 604 and the processing device 602 also constituting machine-readable storage media. In some embodiments, the instructions 626 can be refer to executable instructions. The machine-readable storage medium 624, data storage system 618, and/or main memory 604 can correspond to the memory sub-system 110 of FIG. 1.

In some embodiments, the instructions 626 include instructions to implement functionality corresponding to the power-off duration component 113 of FIG. 1). While the machine-readable storage medium 624 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a memory device comprising a plurality of blocks; and
a processing device operatively coupled with the memory device, the processing device to perform operations comprising:
detecting a power-on command for the memory device when the memory device is in a powered-off state;
obtaining read information from a reference block of the plurality of blocks, wherein the read information is based on a reference data stored in the reference block;
determining, based on the read information from the reference block, an estimate of a duration for which the memory device was in the powered-off state;
determining whether the duration satisfies a duration threshold; and
responsive to determining the duration satisfies the duration threshold, initiating a folding operation for at least a subset of the plurality of blocks.

2. The memory sub-system of claim 1, further comprising:
responsive to detecting a power-off command, writing second reference data to the reference block, wherein the reference data is stored in a first portion of the reference block, and wherein the second reference data is written to a second portion of the reference block.

3. The memory sub-system of claim 1, wherein obtaining the read information comprises:
performing a first adjustment to a read threshold voltage value based on physical characteristics of the memory device;
performing a read operation on the reference block at the first adjustment of the read threshold voltage value; and
responsive to determining an error value associated with the read operation satisfies an error threshold, obtaining the read information.

4. The memory sub-system of claim 3, further comprising:
responsive to determining the error value associated with the read operation does not satisfy the error threshold, performing a second adjustment to the read threshold voltage value based on physical characteristics of the memory device, wherein the second adjustment is different from the first adjustment;
performing a second read operation on the reference block at the second adjustment of the read threshold voltage value; and
responsive to determining a second error value associated with the second read operation satisfies the error threshold, identifying the read information.

5. The memory sub-system of claim 1, wherein determining an estimate of the duration for which the memory device was in the powered-off state comprises:
responsive to determining the read information reflects an expected read information, indicating the estimate of the duration, wherein the expected read information is based on a pre-characterization table corresponding to one or more physical characteristics of the memory device.

6. The memory sub-system of claim 1, further comprising:
responsive to determining the duration does not satisfy the duration threshold, determining whether the folding operation has previously been initiated; and
responsive to determining the folding operation has previously been initiated, folding a next block of the subset of the plurality of blocks.

7. The memory sub-system of claim 6, further comprising:
responsive to determining the folding operation has not previously been initiated, performing a subsequent memory operation on the memory device.

8. A method comprising:
detecting a power-on command for a memory device when the memory device is in a powered-off state;
obtaining read information from a reference block of a plurality of blocks of the memory device, wherein the read information is based on a reference data stored in the reference block;
determining, based on the read information from the reference block, an estimate of a duration for which the memory device was in the powered-off state;
determining whether the duration satisfies a duration threshold; and
responsive to determining the duration satisfies the duration threshold, initiating a folding operation for at least a subset of the plurality of blocks.

9. The method of claim 8, further comprising:
responsive to detecting a power-off command, writing second reference data to the reference block, wherein the reference data is stored in a first portion of the reference block, and wherein the second reference data is written to a second portion of the reference block.

10. The method of claim 8, wherein obtaining the read information comprises:
performing a first adjustment to a read threshold voltage value based on physical characteristics of the memory device;
performing a read operation on the reference block at the first adjustment of the read threshold voltage value; and
responsive to determining an error value associated with the read operation satisfies an error threshold, obtaining the read information.

11. The method of claim 10, further comprising:
responsive to determining the error value associated with the read operation does not satisfy the error threshold, performing a second adjustment to the read threshold voltage value based on physical characteristics of the memory device, wherein the second adjustment is different from the first adjustment;
performing a second read operation on the reference block at the second adjustment of the read threshold voltage value; and
responsive to determining a second error value associated with the second read operation satisfies the error threshold, identifying the read information.

12. The method of claim 8, wherein determining an estimate of the duration for which the memory device was in the powered-off state comprises:
responsive to determining the read information reflects an expected read information, indicating the estimate of the duration, wherein the expected read information is based on a pre-characterization table corresponding to one or more physical characteristics of the memory device.

13. The method of claim 8, further comprising:
responsive to determining the duration does not satisfy the duration threshold, determining whether the folding operation has previously been initiated; and
responsive to determining the folding operation has previously been initiated, folding a next block of the subset of the plurality of blocks.

14. The method of claim 13, further comprising:
responsive to determining the folding operation has not previously been initiated, performing a subsequent memory operation on the memory device.

15. A computer-readable non-transitory storage medium comprising executable instructions that, when executed by a controller managing a memory device comprising a plurality of memory cells, cause the controller to perform operations comprising:
detecting a power-on command for a memory device when the memory device is in a powered-off state;
obtaining read information from a reference block of a plurality of blocks of the memory device, wherein the read information is based on a reference data stored in the reference block;
determining, based on the read information from the reference block, an estimate of a duration for which the memory device was in the powered-off state;
determining whether the duration satisfies a duration threshold; and
responsive to determining the duration satisfies the duration threshold, initiating a folding operation for at least a subset of the plurality of blocks.

16. The computer-readable non-transitory storage medium of claim 15, further comprising:
responsive to detecting a power-off command, writing second reference data to the reference block, wherein the reference data is stored in a first portion of the reference block, and wherein the second reference data is written to a second portion of the reference block.

17. The computer-readable non-transitory storage medium of claim 15, wherein obtaining the read information comprises:
performing a first adjustment to a read threshold voltage value based on physical characteristics of the memory device;
performing a read operation on the reference block at the first adjustment of the read threshold voltage value; and
responsive to determining an error value associated with the read operation satisfies an error threshold, obtaining the read information.

18. The computer-readable non-transitory storage medium of claim 17, further comprising:
responsive to determining the error value associated with the read operation does not satisfy the error threshold, performing a second adjustment to the read threshold voltage value based on physical characteristics of the memory device, wherein the second adjustment is different from the first adjustment;
performing a second read operation on the reference block at the second adjustment of the read threshold voltage value; and
responsive to determining a second error value associated with the second read operation satisfies the error threshold, identifying the read information.

19. The computer-readable non-transitory storage medium of claim 15, wherein determining an estimate of the duration for which the memory device was in the powered-off state comprises:
responsive to determining the read information reflects an expected read information, indicating the estimate of the duration, wherein the expected read information is based on a pre-characterization table corresponding to one or more physical characteristics of the memory device.

20. The computer-readable non-transitory storage medium of claim 15, further comprising:
responsive to determining the duration does not satisfy the duration threshold, determining whether the folding operation has previously been initiated; and
responsive to determining the folding operation has previously been initiated, folding a next block of the subset of the plurality of blocks.
